(19) United States
(12) Patent Application Publication
(10) Pub. No.: US 2009/0037728 A1
(43) Pub. Date: Feb. 5, 2009

(54) Authentication System, CE Device, Mobile Terminal, Key Certificate Issuing Station, And Key Certificate Acquisition Method

(75) Inventor: Atsushi Kamikura, Tokyo (JP)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co., Ltd., Osaka (JP)

(21) Appl. No.: 12/280,675

(22) PCT Filed: Feb. 28, 2006
(86) PCT No.: PCT/JP2006/303774

§ 371 Date: Aug. 25, 2008

(51) Int. Cl. H04L 9/32; H04L 9/08; H04L 9/30

(52) U.S. Cl. 713/156; 380/282

(57) ABSTRACT

Provided is an authentication system for improving user-friendliness. An IC card (100) of the authentication system (10) includes: a key/certificate storage unit (120) connected to a terminal device (200) and capable of storing a key pair and a temporary certificate or a permanent certificate while correlating them; a CE temporary public key certificate acquisition unit (170); and a CE public key/certificate acquisition control unit (150) connected to a CE device (300). When the key/certificate storage unit (120) has a key pair not correlated either to a temporary certificate or a permanent certificate, the CE temporary public key certificate acquisition unit (170) acquires a temporary certificate corresponding to the key pair from a public key certificate issuing station (400) by using the mobile terminal (200) and causes the key/certificate storage unit (120) to store it. When the key/certificate storage unit (120) has a key pair correlated a temporary certificate but not to a permanent certificate, the CE public key/certificate acquisition control unit (150) acquires a permanent certificate from the public key certificate issuing station (400) by using the temporary certificate via the CE device (300) and causes the key/certificate storage unit (120) to store it.

### TECHNICAL FIELD

The present invention relates to an authentication system, CE device, mobile terminal, key certificate issuing station, and key certificate acquisition method.

### BACKGROUND ART

In recent years, there has been a great increase in the distribution of audio and video content via the Internet, and users can easily acquire content they want. However, as the Internet is an environment that is open to all manner of users, illegal acquisition of content by malicious users is a problem. One method of solving this problem is a system that performs authentication when a user accesses a content server holding content.

However, even when user authentication is carried out, there is still a possibility of downloaded content being illegally copied or distributed if a user performs connection by means of an illegal device. Therefore, in addition to the above user authentication for preventing illegal use, there is a need for device authentication to check whether a device used by a user for content downloading is an illegal device.

An example of simple and inexpensive implementation of this user authentication and device authentication is shown in Patent Document 1. FIG. 1 shows the information device security authentication method and system configuration disclosed in Patent Document 1.

First, when a user uses an Internet connection by means of a consumer electronics device, the user sends a usage application to an ISP (Internet Service Provider). The usage application in this case may be made by means of e-mail using another information device, a postcard, or the like.

On receiving a usage application from a user, the ISP converts it to data and records it in a consumer electronics device management DB. This data includes a password assigned to each type of consumer electronics device.

The ISP also transmits a user's usage application data to a consumer electronics device authentication system. The consumer electronics device authentication system generates a provisional password based on the received usage application data, and transmits this to the ISP.

The ISP records the received password, associated with the previously recorded user's usage application data, in the consumer electronics device management DB, and also sends it to the user by means of e-mail, a postcard, or the like.

After receiving the provisional password, the user next acquires formal device authentication information. Acquisition of device authentication information is performed by means of the following kind of procedure.

The user connects to the consumer electronics device authentication system using a consumer electronics device. When connected to the consumer electronics device authentication system, the user inputs the provisional password via the consumer electronics device, and the consumer electronics device transmits the input provisional password and a model-specific password stored in the storage section of the consumer electronics device to the consumer electronics device authentication system.

The consumer electronics device authentication system connects to the consumer electronics device management DB, and compares the received provisional password and model-specific password with a provisional password and model-specific password stored in the consumer electronics device management DB. If an item matching the received provisional password and model-specific password exists in the consumer electronics device management DB, the consumer electronics device authentication system generates device authentication information and transmits the device authentication information to the user's consumer electronics device.

By this means, a consumer electronics device can acquire device authentication information, and can perform device authentication using the device authentication information in subsequent Internet connection.

A Public Key Infrastructure (PKI) is used in authentication. A PKI is an infrastructure that provides security services comprising protection of confidentiality, authentication, integrity, and denial prevention, by providing encryption and digital signature functions. In this PKI, a certificate authority issues a public key certificate certifying the identity of a user.

Authentication when a user's client device connects to a server device holding content is shown below.

When a server device access request is generated by a client device, the client device and server device acquire each other's public key certificate. Possible acquisition methods are public key certificate acquisition from the other party, acquisition from a repository, or the like.

On acquiring the communicating party's public key certificate, each device verifies the legitimacy and validity of the public key certificate by means of the signature, period of validity, and so forth, of the public key certificate. When the public key certificates are determined to be legitimate and valid, each device verifies that the communicating party is the legitimate owner of the public key certificate. A signature provided by a private key forming a pair with the public key contained in the public key certificate is used in this verification. Each device can verify that the communicating party is the legitimate owner of the previously acquired public key certificate by performing a signature by means of a private key possessed by itself in a value shared with the communicating party, and transmitting this to the communicating party.

As described above, with a PKI, user authentication can be performed by having a user possess a public key/private key pair, but in authentication according to a standard PKI, it is not possible to check what kind of authority a user possesses. Thus, as a method of performing access control in authentication using a public key certificate, there is a method whereby attribute information for determining access authority is provided in an extension area of a public key certificate. Applications that provide authentication and encrypted communication using the above kind of public key certificate include SSL, IPsec, and so forth.

### Patent Document 1: Japanese Patent Application Laid-Open No. 2004-355396

### DISCLOSURE OF INVENTION

### Problems to be Solved by the Invention

With the conventional system shown in Patent Document 1, device-unit unique authentication is implemented not by incorporating device-unit unique device authentication information during consumer electronics device production, but by using a model-specific password assigned on a model-by-model basis.

However, in a conventional system, it is necessary for a user to make a usage application by means of e-mail, a postcard, or the like, which requires time and effort on the part of the user. Moreover, if a user owns a plurality of consumer electronics devices, still more time and effort is required on the part of the user, and user-friendliness is poor. In addition, an ISP incurs costs due to the complexity of user information management.

The present invention has been implemented taking into account the problems described above, and it is an object of the present invention to provide an authentication system, CE device, mobile terminal, key certificate issuing station, and key certificate acquisition method that improve user-friendliness.

### Means for Solving the Problems

An authentication system of the present invention has a mobile terminal, a CE device, an IC card that is connectable to the mobile terminal and the CE device, and a key certificate issuing station that issues a temporary certificate and permanent certificate for a key pair composed of a public key and private key used by the CE device; wherein the IC card employs a configuration having: a storage section that is capable of storing the key pair and the temporary certificate or the permanent certificate in mutually associated form; a first key certificate acquisition section that acquires a temporary certificate corresponding to the key pair from the key certificate issuing station using the mobile terminal and stores this in the storage section when the first key certificate acquisition section is connected to the mobile terminal and the key pair that is not associated with either the temporary certificate or the permanent certificate exists in the storage section; and a second key certificate acquisition section that acquires the permanent certificate from the key certificate issuing station using the temporary certificate via the CE device and stores this in the storage section when the second key certificate acquisition section is connected to the CE device and the key pair that is associated with the temporary certificate but is not associated with the permanent certificate exists in the storage section.

### ADVANTAGEOUS EFFECT OF THE INVENTION

According to the present invention, an authentication system, CE device, mobile terminal, key certificate issuing station, and key certificate acquisition method can be provided that improve user-friendliness.

### BRIEF DESCRIPTION OF DRAWINGS

FIG. 1 is a drawing providing an explanation of a conventional authentication system;

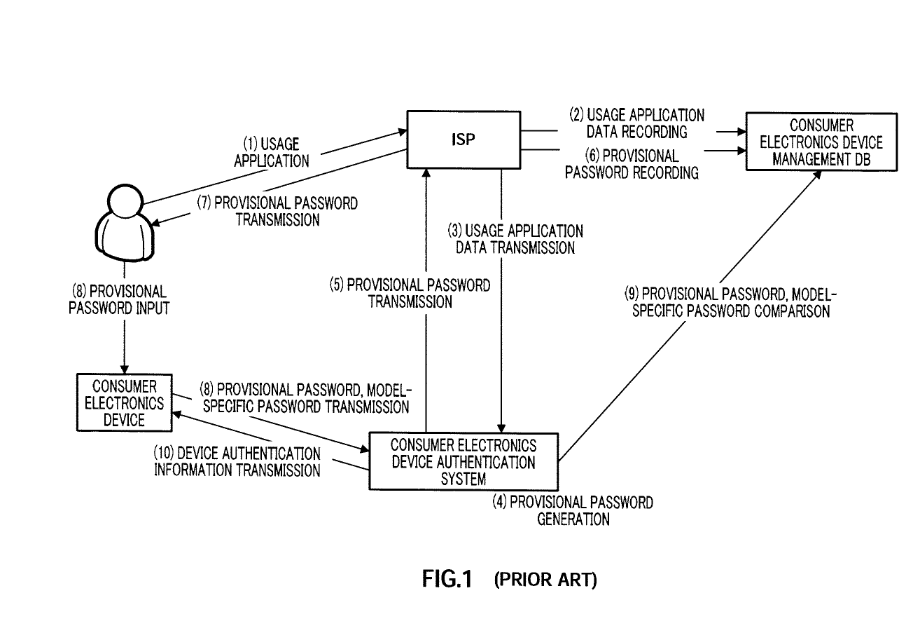

FIG. 2 is a drawing providing an explanation of the overall configuration of an authentication system according to one embodiment of the present invention;

FIG. 3 is a block diagram showing the configuration of the IC card in FIG. 2;

FIG. 4 is a drawing showing one mode of a list stored in the key/certificate storage section in FIG. 3;

FIG. 5 is a block diagram showing the configuration of the CE device in FIG. 2;

FIG. 6 is a block diagram showing the configuration of the mobile terminal in FIG. 2;

FIG. 7 is a block diagram showing the configuration of the public key certificate issuing station in FIG. 2;

FIG. 8 is a drawing showing one mode of a list stored in the public key certificate database in FIG. 7;

FIG. 9 is a drawing providing an explanation of temporary public key certificate issuance processing;

FIG. 10 is a drawing providing an explanation of permanent public key certificate issuance processing; and

FIG. 11 is a drawing providing an explanation of processing for downloading from a content server.

### BEST MODE FOR CARRYING OUT THE INVENTION

An embodiment of the present invention will now be described in detail with reference to the accompanying drawings. In the embodiment, identical configuration elements are assigned the same reference codes, and duplicate descriptions thereof are omitted.

### One Embodiment

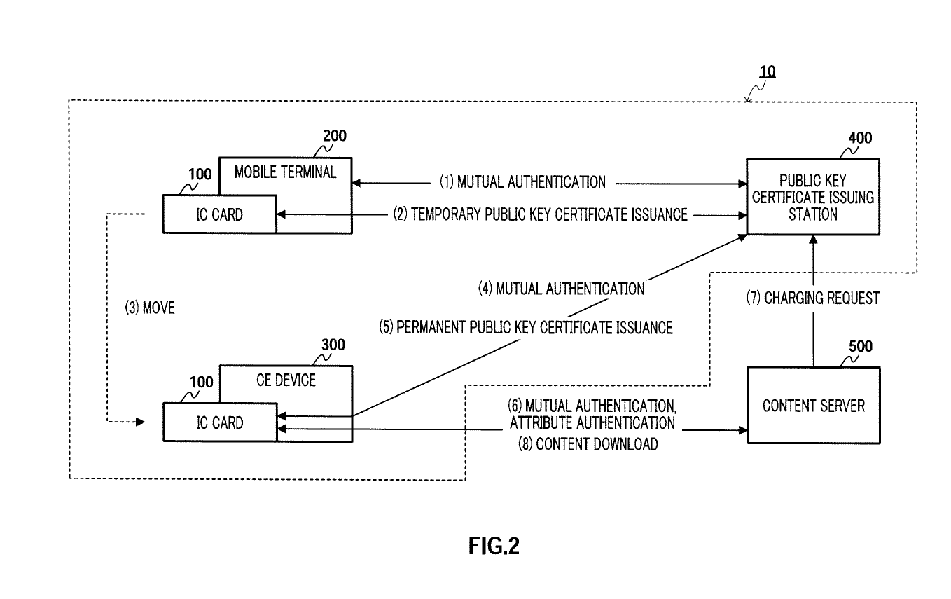

As shown in FIG. 2, authentication system 10 according to this embodiment has IC card 100, mobile terminal 200, CE (Consumer Electronics) device 300, and public key certificate issuing station 400. IC card 100, mobile terminal 200, CE device 300, public key certificate issuing station 400, and content server 500 are connected via the Internet. In authentication system 10, a PKI is used in authentication (user authentication and device authentication).

IC card 100 can store a key pair comprising a public key and private key, and a public key certificate. Mobile terminal 200 is equipped with a card slot, and is connected to IC card 100 by inserting IC card 100 into this card slot. By this means, exchange of data between IC card 100 and mobile terminal 200 becomes possible.

Mobile terminal 200 is configured so as to be able to acquire a public-key/private-key key pair (hereinafter also referred to as “terminal key pair”) and public key certificate (hereinafter also referred to as “terminal public key certificate”) for itself, and in this embodiment, will be described as already possessing these. This terminal key pair and terminal public key certificate may be stored in memory provided in mobile terminal 200, or may be stored in a storage medium separate from IC card 100 that can be accessed from mobile terminal 200. It is assumed that when mobile terminal 200 accesses public key certificate issuing station 400 in order to acquire a terminal public key certificate, public key certificate issuing station 400 records user information including mobile terminal 200 terminal identification information. When mobile terminal 200 connects to public key certificate issuing station 400, it performs mutual authentication with public key certificate issuing station 400 using the private key of the terminal key pair and the terminal public key certificate.

When connecting to content server 500, CE device 300 performs mutual authentication and attribute authentication using its own permanent public key certificate (hereinafter also referred to as “CE permanent public key certificate”) held in IC card 100. After this authentication, CE device 300 can perform downloading of content from content server 500.

When a CE permanent public key certificate is held in IC card 100, CE device 300 can download content from content server 500 as described above, but when a CE permanent public key certificate is not held in IC card 100, it is necessary for CE device 300 to acquire a CE permanent public key certificate from public key certificate issuing station 400 using a CE temporary public key certificate stored in IC card 100, and store this in IC card 10. Also, if neither a CE permanent public key certificate not a CE temporary public key certificate is held in IC card 100, it is necessary for the user to connect IC card 100 to mobile terminal 200, and acquire a temporary public key certificate from public key certificate issuing station 400 by operating mobile terminal 200. When acquiring this temporary public key certificate, the terminal key pair and terminal public key certificate of mobile terminal 200 are used, and therefore a terminal public key certificate corresponding to mobile terminal 200 and a temporary public key certificate can be mutually associated by public key certificate issuing station 400. Furthermore, when CE device 300 acquires a CE permanent public key certificate, CE temporary public key information and consumer electronics device information are used, and therefore public key certificate issuing station 400 can ultimately mutually associate a terminal public key certificate corresponding to mobile terminal 200 and a CE permanent public key certificate (the CE permanent public key certificate coming about through the CE temporary public key certificate and CE device information being mutually associated).

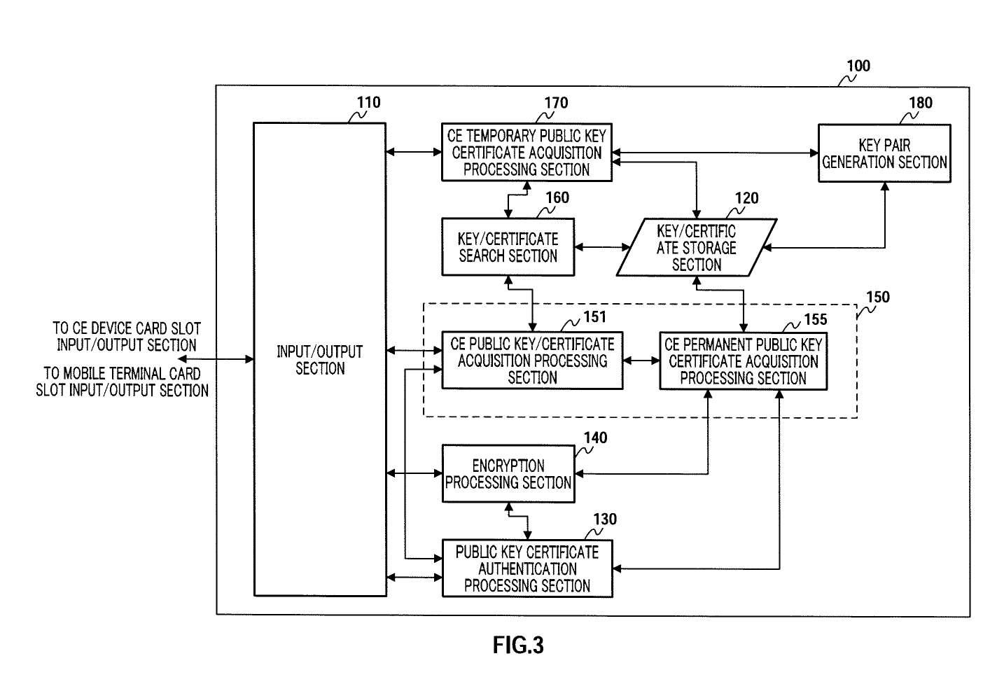

As shown in FIG. 3, IC card 100 has input/output section 110, key/certificate storage section 120, CE public key certificate authentication processing section 130, encryption processing section 140, CE public key/certificate acquisition control section 150, key/certificate search section 160, CE temporary public key certificate acquisition processing section 170, and key pair generation section 180. CE public key/certificate acquisition control section 150 has CE public key/certificate acquisition processing section 151 and CE permanent public key certificate acquisition processing section 155.

Input/output section 110 performs data transmission/reception from/to IC card 100. When IC card 100 is inserted into the card slot of mobile terminal 200 or CE device 300, and input/output section 110 is connected to the input/output section of mobile terminal 200 or CE device 300, data transmission/reception can be performed between IC card 100 and mobile terminal 200 or CE device 300.

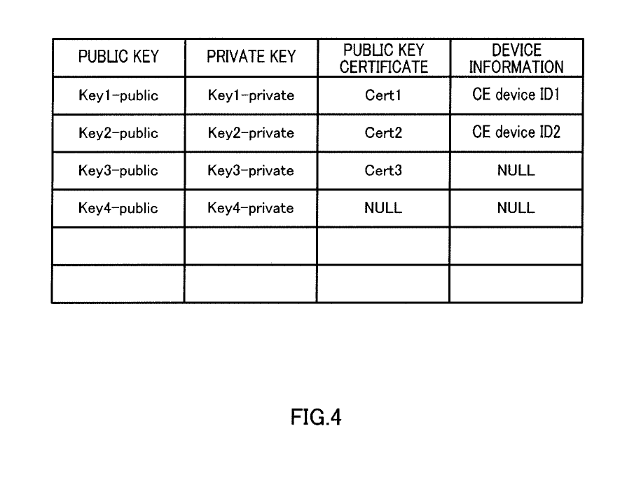

Key/certificate storage section 120 stores a public key and private key of CE device 300 (hereinafter also referred to as “CE key pair”), together with a public key certificate corresponding to that CE key pair (hereinafter also referred to as “CE public key certificate”). In key/certificate storage section 120, CE key pairs and CE public key certificates are managed in the form of a list such as shown in FIG. 4, for example. The list in FIG. 4 includes CE key pairs, CE public key certificates, and public key certificate attributes. Information uniquely assigned to an individual CE device 300, such as a device ID, (hereinafter also referred to as “CE device information”) is used as a public key certificate attribute.

Here, a public key certificate associated with CE device information is referred to as a “CE permanent public key certificate”, and a public key certificate with which with CE device information is not associated is referred to as a “CE temporary public key certificate”. That is to say, in FIG. 4, public key certificates Cert1 and Cert2 are permanent public key certificates, and public key certificate Cert3 is a temporary public key certificate.

Public key certificate authentication processing section 130 performs mutual authentication with an apparatus on a network using a private key and CE public key certificate stored in key/certificate storage section 120. Specifically, public key certificate authentication processing section 130 acquires a CE key pair and CE public key certificate used in mutual authentication from key/certificate storage section 120 via CE public key/certificate acquisition control section 150. Public key certificate authentication processing section 130 also performs certificate transmission, certificate authentication, signature generation, signature authentication, and so forth, in mutual authentication processing, and performs information exchange with the mutual authentication counterpart at that time via input/output section 110. When mutual authentication is successful, public key certificate authentication processing section 130 generates an encryption key used by encryption processing section 140, and outputs this encryption key to encryption processing section 140. Public key certificate authentication processing section 130 may also update the encryption processing section 140 encryption key periodically by periodically generating an encryption key and outputting this to encryption processing section 140.

Encryption processing section 140 performs encrypted communication with the counterpart apparatus using an encryption key received from public key certificate authentication processing section 130 after mutual authentication succeeds.

CE temporary public key certificate acquisition processing section 170 executes processing to acquire a new CE public key certificate associated with a terminal public key certificate of mobile terminal 200 in which IC card 100 has been inserted. When a CE temporary public key certificate acquisition operation is executed in mobile terminal 200 and a temporary public key acquisition processing start message is received from the CE public key certificate acquisition processing section of mobile terminal 200, CE temporary public key certificate acquisition processing section 170 searches for a key pair that does not have a public key certificate using key/certificate search section 160.

Then, if a key pair that does not have a public key certificate exists, CE temporary public key certificate acquisition processing section 170 performs CE temporary public key certificate acquisition processing for that key pair. Specifically, CE temporary public key certificate acquisition processing section 170 sends a temporary public key certificate issuance request message for that key pair to the CE public key certificate acquisition processing section of mobile terminal 200.

On the other hand, if a key pair that does not have a public key certificate does not exist, CE temporary public key certificate acquisition processing section 170 issues a request for key pair generation to key pair generation section 180, and acquires the generated key pair. Then CE temporary public key certificate acquisition processing section 170 sends a temporary public key certificate issuance request message for that key pair to the CE public key certificate acquisition processing section of mobile terminal 200.

Then a CE temporary public key certificate is acquired from public key certificate issuing station 400 by the CE public key certificate acquisition processing section of mobile terminal 200 that received the temporary public key certificate issuance request message, and CE temporary public key certificate acquisition processing section 170 acquires a CE temporary public key certificate via the CE public key certificate acquisition processing section of mobile terminal 200. On acquiring the CE temporary public key certificate, CE temporary public key certificate acquisition processing section 170 sends the acquired CE temporary public key certificate to key/certificate storage section 120. Then the CE temporary public key certificate and key pair are stored in key/certificate storage section 120 in mutually associated form.

On reception of a key pair generation request from CE temporary public key certificate acquisition processing section 170, key pair generation section 180 generates a new key pair, outputs the generated key pair to CE temporary public key certificate acquisition processing section 170, and also sends the key pair to key/certificate storage section 120, where the key pair is stored.

When IC card 100 is connected by being inserted into the card slot of CE device 300, CE public key/certificate acquisition control section 150 acquires CE device information from CE device 300. This CE device information includes an ID uniquely assigned to CE device 300, model number, model name, executable function information, and so forth.

CE public key/certificate acquisition control section 150 performs processing to acquire a CE key pair and CE permanent public key certificate from key/certificate storage section 120 using the acquired CE device information as a key. Specifically, CE public key/certificate acquisition control section 150 searches key/certificate storage section 120 using key/certificate search section 160. Then, if there is a CE permanent public key certificate—that is, if there is a CE public key certificate corresponding to the above-described acquired CE device information—CE public key/certificate acquisition control section 150 acquires that CE permanent public key certificate and the CE key pair corresponding thereto, and sends these to public key certificate authentication processing section 130.

If a CE permanent public key certificate does not exist but there is a CE temporary public key certificate—that is, if a CE permanent public key certificate does not exist but a CE public key certificate that is not associated with CE device information is present in the list—CE public key/certificate acquisition control section 150 acquires that CE temporary public key certificate and the CE key pair corresponding thereto. Then CE public key/certificate acquisition control section 150 generates a permanent public key certificate issuance request based on the acquired CE device information and temporary public key certificate, and transmits this to public key certificate issuing station 400 via CE device 300. CE device information and a CE public key certificate associated therewith (that is, a CE permanent public key certificate) are returned from public key certificate issuing station 400 in response to this permanent public key certificate issuance request, and CE public key/certificate acquisition control section 150 acquires CE device information and a CE permanent public key certificate via the CE public key certificate acquisition processing section of CE device 300 and input/output section 110.

To be more specific, when IC card 100 is connected by being inserted into the card slot of CE device 300, CE public key/certificate acquisition processing section 151 of CE public key/certificate acquisition control section 150 sends a CE device information transmission request to CE device 300, and acquires CE device information from device information storage section 310 in response to this request.

When IC card 100 is connected by being inserted into the card slot of CE device 300, CE public key/certificate acquisition processing section 151 acquires CE device information from CE device 300. Then CE public key/certificate acquisition processing section 151 performs processing to acquire a CE key pair and CE permanent public key certificate from key/certificate storage section 120 using the acquired CE device information as a key. Specifically, CE public key/certificate acquisition processing section 151 searches key/certificate storage section 120 using key/certificate search section 160. Then, if there is a CE permanent public key certificate—that is, if there is a CE public key certificate corresponding to the above-described acquired CE device information—CE public key/certificate acquisition processing section 151 acquires that CE permanent public key certificate and the CE key pair corresponding thereto, and sends these to public key certificate authentication processing section 130.

If a CE permanent public key certificate does not exist but there is a CE temporary public key certificate—that is, if a CE permanent public key certificate does not exist but a CE public key certificate that is not associated with CE device information is present in the list—CE public key/certificate acquisition processing section 151 acquires that CE temporary public key certificate and the CE key pair corresponding thereto, and sends these to CE permanent public key certificate acquisition processing section 155.

CE permanent public key certificate acquisition processing section 155 generates a permanent public key certificate issuance request based on the acquired CE device information and temporary public key certificate, and transmits this to public key certificate issuing station 400 via encryption processing section 140, input/output section 110, and CE device 300. CE device information and a CE public key certificate associated therewith (that is, a CE permanent public key certificate) are returned from public key certificate issuing station 400 in response to this permanent public key certificate issuance request, and CE permanent public key certificate acquisition processing section 155 acquires CE device information and a CE permanent public key certificate via CE public key certificate acquisition processing section 330 of CE device 300, input/output section 110, and encryption processing section 140.

Then CE permanent public key certificate acquisition processing section 155 outputs the acquired CE device information and CE permanent public key certificate to key/certificate storage section 120, where they are stored.

In CE permanent public key certificate acquisition, a CE key pair used for a CE temporary public key certificate may be used, or a CE permanent public key certificate may be acquired for a newly generated key pair.

Key/certificate search section 160 receives a key search request from CE temporary public key certificate acquisition processing section 170, and a search request for a key/public key certificate including CE device information received from CE public key/certificate acquisition control section 150, and searches key/certificate storage section 120.

On reception of a search request from CE temporary public key certificate acquisition processing section 170, key/certificate search section 160 searches for a CE key pair having neither a CE permanent public key certificate nor a CE temporary public key certificate in key/certificate storage section 120. If the result of the search is that a CE key pair having neither a CE permanent public key certificate nor a CE temporary public key certificate exists, key/certificate search section 160 outputs that CE key pair to CE temporary public key certificate acquisition processing section 170. On the other hand, if the result of the search is that a CE key pair having neither a CE permanent public key certificate nor a CE temporary public key certificate does not exist, key/certificate search section 160 outputs a message to that effect to CE temporary public key certificate acquisition processing section 170.

In response to a key/public key certificate search request from CE public key/certificate acquisition control section 150, key/certificate search section 160 first searches for a CE permanent public key certificate containing CE device information as attribute information. If a CE permanent public key certificate exists, key/certificate search section 160 sends that CE permanent public key certificate and CE key pair to CE public key/certificate acquisition control section 150. On the other hand, if the result of the search is that a CE permanent public key certificate does not exist, key/certificate search section 160 searches for a CE temporary public key certificate. If the result of the search is that a CE temporary public key certificate exists, key/certificate search section 160 sends that CE temporary public key certificate and CE key pair to CE public key/certificate acquisition control section 150. If the result of the search is that a CE temporary public key certificate does not exist, key/certificate search section 160 sends a message to that effect to CE public key/certificate acquisition control section 150.

If there is an expired CE public key certificate (that is, a CE public key certificate whose period of validity has expired) in a CE public key certificate search, key/certificate search section 160 excludes that expired CE public key certificate from the search results, or notifies the user of the apparatus in which IC card 100 is inserted that an expired CE public key certificate has been found.

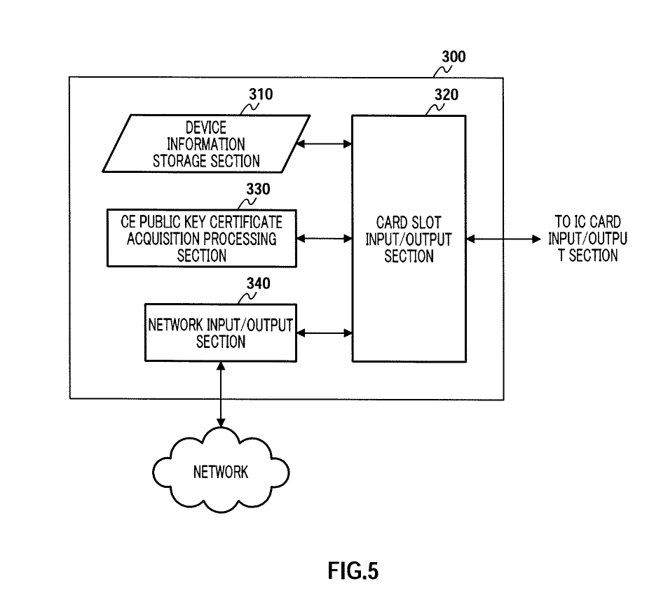

As shown in FIG. 5, CE device 300 has device information storage section 310, card slot input/output section 320, CE public key certificate acquisition processing section 330, and network input/output section 340. In FIG. 5, recording and playback functions of CE device 300 are omitted, and only function blocks relating to IC card 100 are shown.

Device information storage section 310 stores CE device 300 related information (for example, a device-specific ID, manufacturer's name, model name, executable functions, and so forth). As stated above, CE device 300 is equipped with an IC card slot. When IC card 100 is inserted, device information storage section 310 sends CE device information to IC card 100 via card slot input/output section 320. To prevent illegal use, provision may be made for device information storage section 310 writing not to be possible from outside.

Card slot input/output section 320 performs information transmission/reception to/from IC card 100 inserted in the IC card slot.

CE public key certificate acquisition processing section 330 receives a CE permanent public key certificate issuance request from CE public key/certificate acquisition control section 150, and transmits it to public key certificate issuing station 400.

Network input/output section 340 performs information transmission/reception to/from an external network.

Although not shown in FIG. 5, CE device 300 may also have an encryption processing section. This encryption processing section receives an encryption key generated by mutual authentication using a public key certificate in IC card 100, and performs encryption processing in CE device 300. By this means, content data decrypted on the CE device 300 side can be stored when a content download is performed.

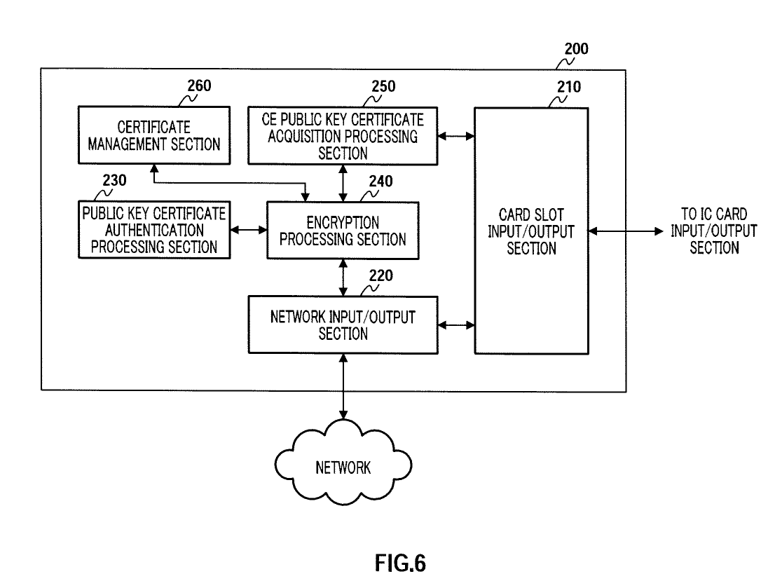

As shown in FIG. 6, mobile terminal 200 has card slot input/output section 210, network input/output section 220, public key certificate authentication processing section 230, encryption processing section 240, CE public key certificate acquisition processing section 250, and certificate management section 260.

Card slot input/output section 210 performs information transmission/reception to/from IC card 100.

Network input/output section 220 performs information transmission/reception to/from an external network.

Public key certificate authentication processing section 230 performs mutual authentication with a communicating party on a network, using a terminal key pair and a terminal public key certificate corresponding thereto. An encryption key generated by the success of mutual authentication is sent to encryption processing section 240 of mobile terminal 200. A private key/public key terminal key pair and terminal public key certificate may be stored in the memory of mobile terminal 200, or may be stored in a removable IC card, separate from IC card 100, that can be accessed from mobile terminal 200.

When IC card 100 is inserted into the card slot and a CE public key certificate acquisition operation is performed by that apparatus, CE public key certificate acquisition processing section 250 sends a CE temporary public key acquisition processing start message to CE temporary public key certificate acquisition processing section 170 of IC card 100. Also, on reception of a temporary public key certificate issuance request message from CE temporary public key certificate acquisition processing section 170 of IC card 100, CE public key certificate acquisition processing section 250 transfers it to public key certificate issuing station 400 via network input/output section 220. At this time, a secure connection established by mutual authentication between mobile terminal 200 and public key certificate issuing station 400 using the terminal public key certificate of mobile terminal 200 is used.

Certificate management section 260 performs management of a CE public key certificate issued to CE device 300 associated with the terminal public key certificate of mobile terminal 200. When a certificate management function is executed in mobile terminal 200, public key certificate authentication processing section 230 establishes a secure connection with public key certificate issuing station 400 using the terminal public key certificate of mobile terminal 200. Then public key certificate authentication processing section 230 acquires information from public key certificate issuing station 400, and can perform viewing and invalidation operations on information of a public key certificate associated with the terminal public key certificate of mobile terminal 200 and issued to CE device 300 (including a CE permanent public key certificate associated with CE device information, and a CE temporary public key certificate not yet associated with CE device information).

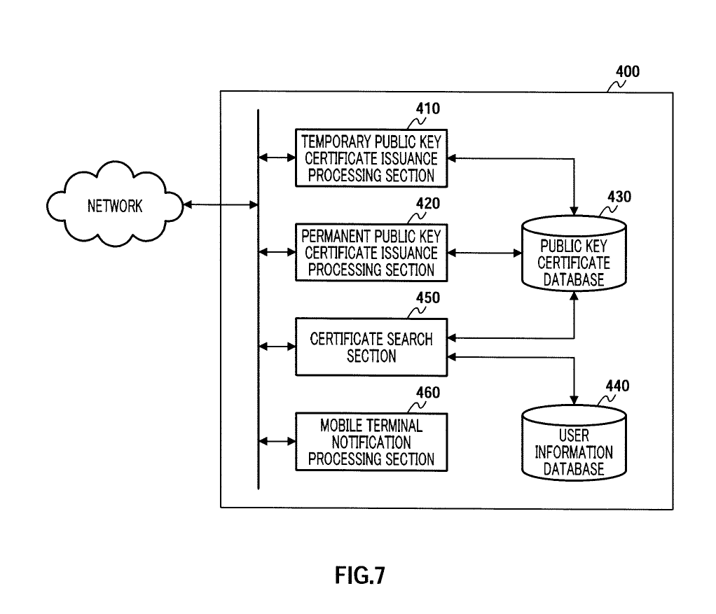

As shown in FIG. 7, public key certificate issuing station 400 has temporary public key certificate issuance processing section 410, permanent public key certificate issuance processing section 420, public key certificate database 430, user information database 440, certificate search section 450, and mobile terminal notification processing section 460.

Public key certificate issuing station 400 performs issuance processing for a CE temporary public key certificate, which is a public key certificate that does not include CE device information, and a CE permanent public key certificate, which is a public key certificate that includes CE device information.

On reception of a CE temporary public key certificate issuance request message transmitted from CE temporary public key certificate acquisition processing section 170 of IC card 100 via mobile terminal 200, and being able to confirm that IC card 100 possesses a legitimate CE key pair, temporary public key certificate issuance processing section 410 issues a CE temporary public key certificate and transmits this to CE temporary public key certificate acquisition processing section 170 of IC card 100 via mobile terminal 200. Temporary public key certificate issuance processing section 410 also records the issued CE temporary public key certificate in public key certificate database 430.

On reception of a CE permanent public key certificate issuance request transmitted from CE public key/certificate acquisition control section 150 of IC card 100 via CE device 300, and being able to confirm that IC card 100 possesses a legitimate CE key pair and CE temporary public key certificate, permanent public key certificate issuance processing section 420 issues a CE permanent public key certificate and transmits this to CE public key/certificate acquisition control section 150 of IC card 100 via CE device 300. Permanent public key certificate issuance processing section 420 also records the issued CE permanent public key certificate in public key certificate database 430.

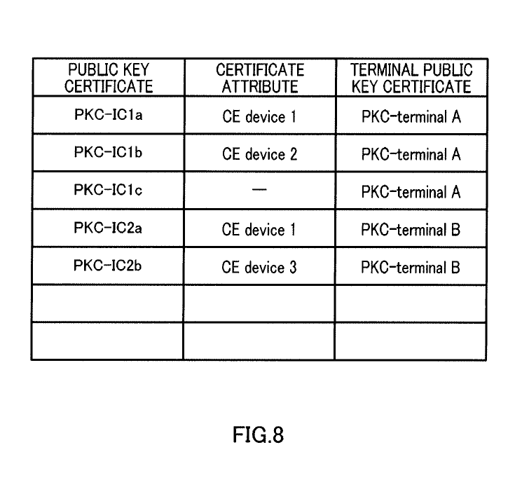

Public key certificate database 430 performs management of CE temporary public key certificates and CE permanent public key certificates. Specifically, public key certificate database 430 manages public key certificates (including CE temporary public key certificates and CE permanent public key certificates) with the kind of list shown in FIG. 8. In this list, a mobile terminal 200 terminal public key certificate and a public key certificate for CE device 300 (CE temporary public key certificate or CE permanent public key certificate) are mutually associated. To identify whether a public key certificate for CE device 300 is a temporary public key certificate or a permanent public key certificate, a public key certificate for CE device 300 is also associated with CE device information. A public key certificate for CE device 300 not yet associated with CE device information is a CE temporary public key certificate; specifically, public key certificate PKC-IC1c in the list in FIG. 8 is a CE temporary public key certificate.

In user information database 440, personal information acquired when a public key certificate is issued to mobile terminal 200 (public key certificate serial number, name, address, telephone number, e-mail address, account number, and so forth) is recorded.

Certificate search section 450 performs a search of mutual association between a public key certificate for CE device 300 and a mobile terminal 200 terminal public key certificate. Certificate search section 450 searches for a terminal public key certificate with which a public key certificate for the target CE device 300 is associated in public key certificate database 430. Then, using the terminal public key certificate resulting from the public key certificate database 430 search as a key, certificate search section 450 acquires user information of mobile terminal 200 corresponding to that terminal public key certificate from the user information database.

When a public key certificate for CE device 300 is used, mobile terminal notification processing section 460 notifies mobile terminal 200 corresponding to the terminal public key certificate associated with this public key certificate. Notification can be performed by e-mail, telephone, or the like, using the user information found by certificate search section 450. In addition to mobile terminal 200 notification contents, this notification may include a request for confirmation of use/non-use of a public key certificate for CE device 300.

In the above description, public key certificate issuing station 400 has been described as being equipped with temporary public key certificate issuance processing section 410, permanent public key certificate issuance processing section 420, public key certificate database 430, user information database 440, and certificate search section 450. However, this is not a limitation, and implementation by means of different apparatuses is also possible.

Next, operations in authentication system 10 having the above configuration will be described. Processing in this system is divided into temporary public key certificate issuance processing, permanent public key certificate issuance processing, and processing for downloading from a content server. Each of these types of processing is described below.

[Temporary Public Key Certificate Issuance Processing]

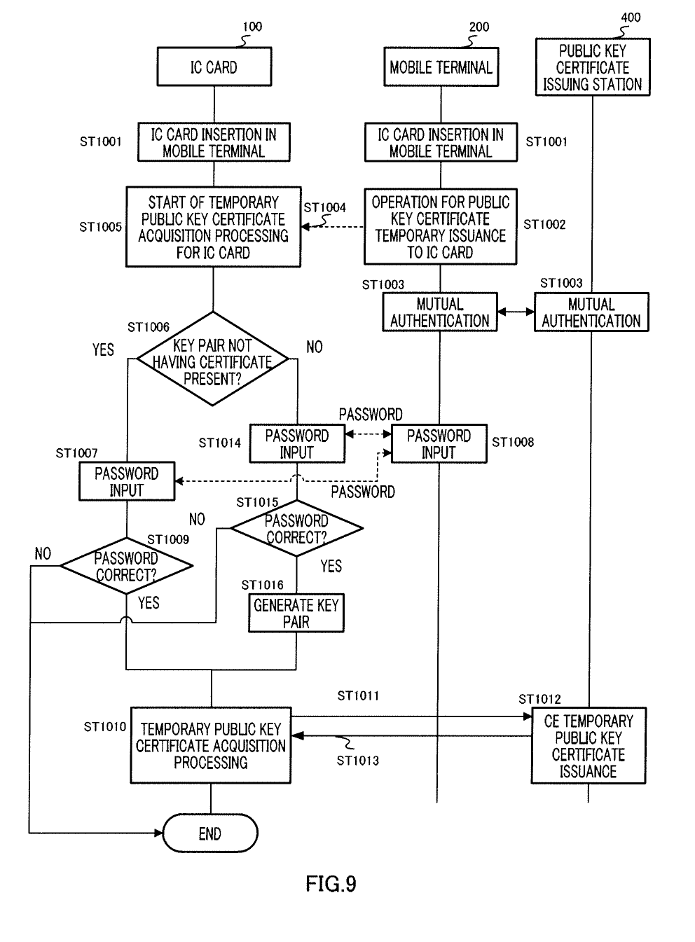

FIG. 9 is a processing flowchart showing above-mentioned temporary public key certificate issuance processing. This temporary public key certificate issuance processing is performed by IC card 100, mobile terminal 200, and public key certificate issuing station 400.

When an operation is performed to start acquisition processing for a public key certificate for CE device 300 (CE temporary public key certificate) in mobile terminal 200 to which IC card 100 is connected (ST1001, ST1002), public key certificate authentication processing section 230 of mobile terminal 200 performs mutual authentication with public key certificate issuing station 400 using a terminal key pair and a terminal public key certificate corresponding thereto in the memory of that apparatus (ST1003).

Also, when an operation is performed to start acquisition processing for a public key certificate for CE device 300 (CE temporary public key certificate) in mobile terminal 200 (ST1001, ST1002), CE public key certificate acquisition processing section 250 of mobile terminal 200 sends a CE temporary public key acquisition processing start message to CE temporary public key certificate acquisition processing section 170 of IC card 100 (ST1004).

In IC card 100, when the CE temporary public key acquisition processing start message is received, CE temporary public key certificate acquisition processing section 170 starts temporary public key certificate acquisition processing (ST1005). When temporary public key certificate acquisition processing is started, CE temporary public key certificate acquisition processing section 170 searches for a key pair that does not have a public key certificate using key/certificate search section 160 (ST1006).

If there is a key pair that does not have a CE public key certificate in ST1006, CE temporary public key certificate acquisition processing section 170 proceeds to acquisition processing for a CE temporary public key certificate for that key pair. To improve security by preventing acquisition of a CE temporary public key certificate by other than the mobile terminal 200 user, CE temporary public key certificate acquisition processing section 170 performs control to display a password request to the user on the display section of mobile terminal 200, and when a user password is input using mobile terminal 200, performs a comparison with a password it holds itself (ST1007, ST1008, ST1009).

If the passwords match in ST1009 and the input password is determined to be correct, CE temporary public key certificate acquisition processing section 170 starts temporary public key certificate acquisition processing for that key pair (ST1010). First, in ST1011, CE temporary public key certificate acquisition processing section 170 of IC card 100 sends a temporary public key certificate issuance request message for that key pair to CE public key certificate acquisition processing section 250 of mobile terminal 200, and on reception of this temporary public key certificate issuance request message, CE public key certificate acquisition processing section 250 of mobile terminal 200 transfers it to public key certificate issuing station 400 via network input/output section 220. At this time, a secure connection established by mutual authentication between mobile terminal 200 and public key certificate issuing station 400 using the terminal public key certificate of mobile terminal 200 (ST1003) is used.

On reception of the temporary public key certificate issuance request message, temporary public key certificate issuance processing section 410 of public key certificate issuing station 400 issues a temporary CE public key certificate (ST1012). At this time, mutual association between the terminal public key certificate of mobile terminal 200 used in the previous mutual authentication and the issued CE temporary public key certificate is performed by public key certificate issuing station 400. The mutual association method may be to hold mutual associations between mobile terminal 200 terminal public key certificates and CE temporary public key certificates as a list, or to write information specific to a mobile terminal 200 terminal public key certificate in an extension area of a CE temporary public key certificate.

In ST1013, temporary public key certificate issuance processing section 410 of public key certificate issuing station 400 transmits the issued CE temporary public key certificate to CE temporary public key certificate acquisition processing section 170 of IC card 100 via CE public key certificate acquisition processing section 250 of mobile terminal 200.

If there is a key pair that does not have a CE public key certificate in ST1006, to improve security by preventing acquisition of a temporary public key certificate by other than the mobile terminal 200 user, CE temporary public key certificate acquisition processing section 170 performs control to display a password request to the user on the display section of mobile terminal 200, and when a user password is input using mobile terminal 200, performs a comparison with a password it holds itself (ST1014, ST1008, ST1015).

If the passwords match in ST1015 and the input password is determined to be correct, CE temporary public key certificate acquisition processing section 170 issues a request for key pair generation to key pair generation section 180, and key pair generation section 180 generates a key pair (ST1016). Then the processing in ST1010 through ST1013 is performed in the same way as described above.

Then, on acquiring a CE temporary public key certificate, CE temporary public key certificate acquisition processing section 170 sends the acquired CE temporary public key certificate to key/certificate storage section 120. The CE temporary public key certificate and key pair are then stored in key/certificate storage section 120 in mutually associated form.

When a CE temporary public key certificate is issued, the possibility of a third party acquiring a CE permanent public key certificate illegally through theft of IC card 100 or the like can be reduced, and security improved, by shortening the period of validity of the CE temporary public key certificate.

[Permanent Public Key Certificate Issuance Processing]

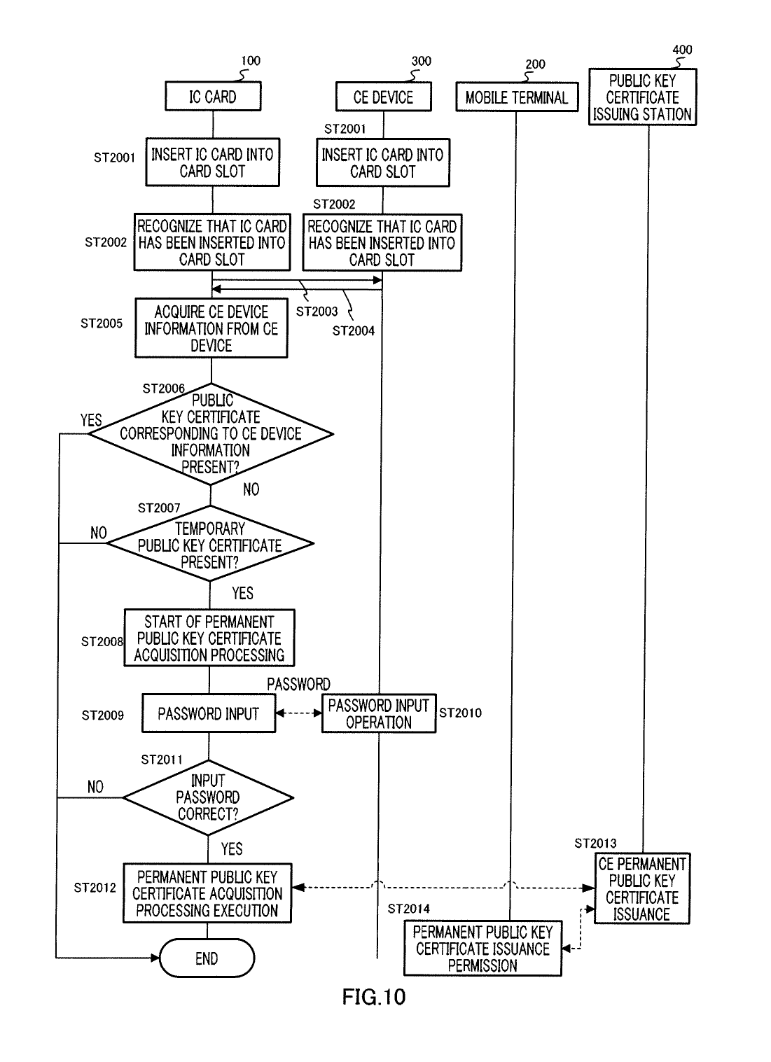

FIG. 10 is a processing flowchart showing above-mentioned permanent public key certificate issuance processing. This permanent public key certificate issuance processing is basically performed by IC card 100, CE device 300, and public key certificate issuing station 400.

When IC card 100 is inserted into the card slot of CE device 300 (ST2001), IC card 100 and CE device 300 recognize that IC card 100 has been inserted into the card slot (ST2002).

Then CE public key/certificate acquisition control section 150 of IC card 100 operates. That is to say, CE public key/certificate acquisition control section 150 sends a CE device information transmission request to CE device 300 (ST2003), and on reception of the device information transmission request, CE device 300 transmits CE device information in device information storage section 310 to CE public key/certificate acquisition control section 150 of IC card 100 (ST2004). Then, in ST2005, CE public key/certificate acquisition control section 150 of IC card 100 acquires the CE device information.

CE public key/certificate acquisition control section 150 of IC card 100 performs processing to acquire a CE key pair and CE public key certificate from key/certificate storage section 120 using the acquired CE device information as a key. Specifically, CE public key/certificate acquisition control section 150 searches key/certificate storage section 120 using key/certificate search section 160 (ST2006).

Then, if the result of the search in ST2006 is that there is a permanent public key certificate—that is, is there is a CE public key certificate corresponding to the above-described acquired CE device information—CE public key/certificate acquisition control section 150 acquires that permanent public key certificate and the CE key pair corresponding thereto, and terminates permanent public key certificate acquisition processing.

If the result of the search in ST2006 is that there is no CE permanent public key certificate, CE public key/certificate acquisition control section 150 searches to see if a CE temporary public key certificate exists (ST2007).

If the result of the search in ST2007 is that a CE temporary public key certificate does not exist either, a CE permanent public key certificate cannot be acquired, and therefore permanent public key certificate acquisition processing ends.

If, in ST2007, a CE permanent public key certificate does not exist but there is a CE temporary public key certificate—that is, if a CE permanent public key certificate does not exist but a CE public key certificate that is not associated with CE device information is present in the list—CE public key/certificate acquisition control section 150 starts permanent public key certificate acquisition processing (ST2008).

To improve security by preventing acquisition of a CE permanent public key certificate by other than the same user as the mobile terminal 200 user, CE public key/certificate acquisition control section 150 performs control to display a password request to the user on the display section of CE device 300, and when a user password is input using CE device 300, performs a comparison with a password it holds itself (ST2009, ST2010, ST2011). If the passwords match in ST2011 and the input password is determined to be correct, CE public key/certificate acquisition control section 150 executes permanent public key certificate acquisition processing (ST2012). That is to say, CE public key/certificate acquisition control section 150 acquires a CE temporary public key certificate and a CE key pair corresponding thereto from key/certificate storage section 120. Then CE public key/certificate acquisition control section 150 generates a permanent public key certificate issuance request based on the acquired CE device information and CE temporary public key certificate, and transmits this to public key certificate issuing station 400 via input/output section 110 and CE public key certificate acquisition processing section 330 of CE device 300.

In ST2013, on reception of the permanent public key certificate issuance request transmitted from CE public key/certificate acquisition control section 150 of IC card 100 via CE device 300, and being able to confirm that IC card 100 possesses a legitimate CE key pair and CE temporary public key certificate, permanent public key certificate issuance processing section 420 of public key certificate issuing station 400 issues a CE permanent public key certificate and transmits this to CE public key/certificate acquisition control section 150 of IC card 100 via CE device 300. To improve security by confirming that the user handling CE device 300 and the user to whom a CE temporary public key certificate was issued are the same, before a public key certificate for CE device 300 is used—specifically, before a CE temporary public key certificate and CE device information are transmitted to CE device 300 in mutually associated form as a permanent public key certificate in ST2013—mobile terminal notification processing section 460 notifies mobile terminal 200 corresponding to the terminal public key certificate with which this temporary public key certificate is associated in public key certificate database 430. User information stored in user information database 440 corresponding to this terminal public key certificate is used for this notification. In this way, illegal acquisition of a permanent public key certificate through theft of IC card 100 or the like can be prevented.

On reception of this notification, the mobile terminal 200 user returns permanent public key certificate issuance permission using mobile terminal 200 (ST2014), and on reception of this issuance permission, permanent public key certificate issuance processing section 420 issues a CE permanent public key certificate and transmits this to CE public key/certificate acquisition control section 150 of IC card 100 via CE device 300.

Then CE public key/certificate acquisition control section 150 acquires the CE permanent public key certificate, and permanent public key certificate acquisition processing ends when that CE permanent public key certificate is stored in key/certificate storage section 120. At this time, CE public key certificate acquisition processing section 330 detects the operation and sends a CE permanent public key certificate acquisition request to CE public key/certificate acquisition control section 150, and CE public key/certificate acquisition control section 150 starts CE permanent public key certificate acquisition processing in response to this request.

In the above description of permanent public key certificate acquisition processing, if it is determined in ST2006 and ST2007 that a permanent public key certificate does not exist but there is a temporary public key certificate, CE public key/certificate acquisition control section 150 automatically starts permanent public key acquisition processing, but this is not a limitation, and CE public key/certificate acquisition control section 150 may also start permanent public key acquisition processing after waiting for a permanent public key certificate acquisition processing operation by the user using CE device 300.

[Download Processing]

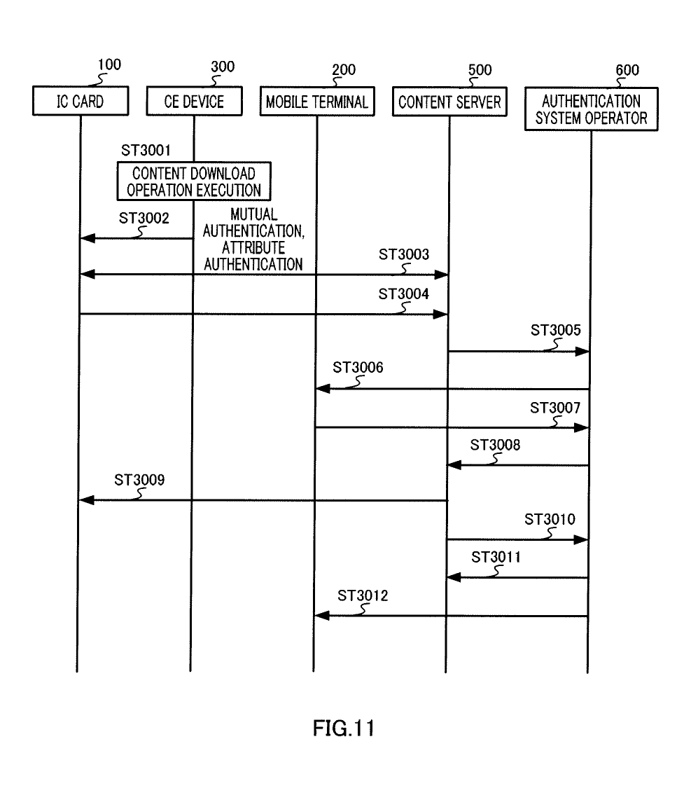

FIG. 11 is a flowchart showing above-mentioned processing for downloading from a content server. This download processing involves IC card 100, mobile terminal 200, CE device 300, content server 500, and authentication system operator facility 600. This authentication system operator facility 600 is composed of above-described public key certificate issuing station 400 and a charging server.

When IC card 100 is inserted into CE device 300 and a CE permanent public key certificate associated with CE device information of that CE device 300 is held in that IC card 100, access to content server 500 from CE device 300 becomes possible.

That is to say, when a content download operation is executed in CE device 300 while IC card 100 is connected to CE device 300 (ST3001), a content download request is sent to IC card 100 (ST3002).

On reception of a content download request from CE device 300, public key certificate authentication processing section 130 of IC card 100 performs mutual authentication with content server 500 using a permanent public key certificate corresponding to this 300 and a key pair corresponding to this permanent public key certificate. Then, when public key certificate and signature verification succeeds through this mutual authentication, content server 500 performs permanent public key certificate attribute confirmation (ST3003). This permanent public key certificate attribute information includes the device ID, manufacturer, model, executable functions, and so forth, of CE device 300 to which IC card 100 is connected, and whether or not access is possible to the apparatus is determined by content server 500 polling.

If content server 500 determines that access is permitted based on the attribute information, content downloading to IC card 100 is possible. Encryption processing section 140 of IC card 100 then transmits a content download request to content server 500 via CE device 300 (ST3004).

Although it is possible for content server 500 to transmit content corresponding to a content download request from IC card 100 at the stage at which that request is received, to improve security, content server 500 here transmits a mobile terminal notification request to mobile terminal notification processing section 460 of public key certificate issuing station 400 in authentication system operator facility 600 in order to obtain confirmation for mobile terminal 200 corresponding to a terminal public key certificate associated with the permanent public key certificate of CE device 300 to which IC card 100 from which the content download request came is connected (ST3005).

Mobile terminal notification processing section 460 of public key certificate issuing station 400 transmits notification to confirmation target mobile terminal 200 of the fact that there is a content download request (ST3006), and when the user using mobile terminal 200 performs confirmation processing, a confirmation response is transmitted to mobile terminal notification processing section 460 from mobile terminal 200 (ST3007).

Mobile terminal notification processing section 460 transfers the received confirmation response to content server 500 (ST3008).

Only on reception of the confirmation response does content server 500 transmit content to IC card 100 via CE device 300 (ST3009). In this way, highly secure content downloading is performed, and illegal downloading of content through theft of IC card 100 or CE device 300 can be prevented. Distributed content may also be converted to an optimal bit rate, size, image quality, or the like, based on attribute information—that is, based on CE device 300 functions or the like.

Then, when content transmission is performed, content server 500 transmits a charging request to the charging server in authentication system operator facility 600 (ST3010).

The charging server manages charging for mobile terminal 200, and also performs collective charging management for content downloading. Therefore, if charging is performed each time a content download is carried out, charging is performed each time a charging request is received from content server 500. Since user identification is possible in this way, charging can be performed for a content download in CE device 300 using the high reliability of mobile terminal 200.

Then, in ST3011 and ST3012, a charging completion notification is transmitted to mobile terminal 200 and content server 500 to report that charging has been completed by the charging hardware.

An operation serving as a content download trigger may also be performed by a mobile terminal. In this embodiment, mobile terminal 200 also has a role of CE device 300 remote controller, and when a content download operation is performed in mobile terminal 200, a content download request is transmitted from mobile terminal 200 to IC card 100 via CE device 300, after which mutual authentication between IC card 100 and content server 500, attribute authentication, notification to mobile terminal 200, and so forth, are performed, and content downloading becomes possible.

In the above description, password input is provided at the time of temporary public key certificate acquisition, permanent public key certificate acquisition, and connection to a content server, but password input may be omitted if the level of security required by an authentication system using the present invention is low.

When password input is provided as described above, the following kinds of password input method are possible.

<Password Input by Means of CE Device 300>

If password input for IC card 100 private key activation is required when IC card 100 inserted in CE device 300 performs mutual authentication with public key certificate issuing station 400 and content server 500, a function possessed by CE device 300 can be used for password input.

For example, if CE device 300 is a video recording apparatus, a signal for performing screen display conveyed to the user regarding whether or not a public key certificate is to be acquired or regarding password input being required is sent to a video display apparatus connected to the video recording apparatus, and screen display is performed. Voice may be used as well as video as a password input prompt to the user. Password input is performed by a button on the recording apparatus or a remote controller.

<Password Input by Means of Mobile Terminal>

When a CE key pair is generated in IC card 100 inserted in mobile terminal 200, or when a private key is activated when issuance of a CE temporary public key certificate is requested for a CE key pair of IC card 100, password input can be performed using a button or the like provided on mobile terminal 200. Also, confirmation of whether or not a CE key pair is to be generated, confirmation of whether or not a CE public key certificate is to be acquired, or notification to the effect that password input is requested, may be displayed on an image display apparatus provided on mobile terminal 200.

Thus, according to this embodiment, in authentication system 10 having mobile terminal 200, CE device 300, IC card 100 that is connectable to mobile terminal 200 and CE device 300, and public key certificate issuing station 400 that issues a temporary certificate (CE temporary public key certificate) and a permanent certificate (CE permanent public key certificate) for a key pair (CE key pair) composed of a public key and a private key used by CE device 300, IC card 100 is equipped with: key/certificate storage section 120 that is capable of storing a key pair and a temporary certificate or permanent certificate in mutually associated form; CE temporary public key certificate acquisition processing section 170 that acquires a temporary certificate corresponding to the key pair from public key certificate issuing station 400 using mobile terminal 200 and stores this in key/certificate storage section 120 when the CE temporary public key certificate acquisition processing section 170 is connected to mobile terminal 200 and a key pair that is not associated with either a temporary certificate or a permanent certificate exists in key/certificate storage section 120; and CE public key/certificate acquisition control section 150 that acquires a permanent certificate from public key certificate issuing station 400 using the temporary certificate via CE device 300 and stores this in key/certificate storage section 120 when the CE public key/certificate acquisition control section 150 is connected to CE device 300 and a key pair that is associated with a temporary certificate but is not associated with a permanent certificate exists in key/certificate storage section 120.

By this means, it is generally possible for a user to be identified, a temporary certificate of a key to be acquired in IC card 100 using high-reliability mobile terminal 200, IC card 100 and CE device 300 then to be connected, and a permanent certificate of the key used by CE device 300 to be acquired using the temporary certificate obtained in a high-reliability environment. Therefore, a permanent certificate of a key can be acquired in a high-reliability environment even when CE device 300 does not have a user registered. Also, heretofore it has been necessary for a user to perform a complex user registration procedure by mail or the like, and then further perform complex processing to acquire device authentication information such as a key and key certificate, each time the user acquires a CE device, but by using above-described authentication system 10, key and key certificate acquisition processing is simplified, and user-friendliness can be improved.

Also, in above-described authentication system 10, CE temporary public key certificate acquisition processing section 170 is connected to mobile terminal 200, and, when a key pair that is not associated with either a temporary certificate or a permanent certificate exists in key/certificate storage section 120, sends a temporary certificate issuance request including a key pair to mobile terminal 200; and mobile terminal 200 is equipped with CE public key certificate acquisition processing section 250 that, on reception of a temporary certificate issuance request, acquires the temporary certificate from public key certificate issuing station 400 via a secure channel using a terminal key pair and terminal key certificate of that apparatus, and sends that temporary certificate to IC card 100.

By this means, a secure channel between mobile terminal 200 and public key certificate issuing station 400 can be used when acquiring a temporary certificate, enabling a temporary certificate to be acquired in a high-reliability environment.

Also, in above-described authentication system 10, CE public key/certificate acquisition control section 150 is connected to CE device 300, and, when a key pair that is associated with a temporary certificate but is not associated with a permanent certificate exists in key/certificate storage section 120, sends a permanent certificate issuance request including a key pair and temporary certificate to CE device 300; and CE device 300 is equipped with CE public key certificate acquisition processing section 330 that, on reception of a permanent certificate issuance request, acquires a permanent certificate from public key certificate issuing station 400 via a secure channel using a temporary certificate, and sends that permanent certificate to IC card 100.

By this means, the key and permanent certificate used by CE device 300 are acquired using a permanent certificate acquired in a high-reliability environment, enabling a key and permanent certificate to be acquired in a high-reliability environment even when CE device 300 does not have a user registered.

Also, in above-described authentication system 10, CE public key certificate acquisition processing section 250, on reception of a temporary certificate issuance request from IC card 100, transmits a temporary certificate issuance request to public key certificate issuing station 400 via a secure channel using a terminal key pair and terminal key certificate of that apparatus (mobile terminal 200); and public key certificate issuing station 400 is equipped with: public key certificate database 430 that is capable of storing a temporary certificate or permanent certificate and a terminal key certificate in mutually associated form; and temporary public key certificate issuance processing section 410 that, on reception of a temporary certificate issuance request, issues a temporary certificate and transmits that temporary certificate to CE public key certificate acquisition processing section 250, and also stores the issued temporary certificate and the terminal key certificate of mobile terminal 200 that is the transmission source of the temporary certificate issuance request in public key certificate database 430 in mutually associated form.

By this means, IC card 100 can acquire a permanent certificate using a secure channel between mobile terminal 200 and public key certificate issuing station 400, and a temporary certificate can also be stored in public key certificate issuing station 400. Therefore, when IC card 100 is next connected to CE device 300, a secure channel can be formed between CE device 300 and public key certificate issuing station 400 using the acquired temporary certificate.

Also, in above-described authentication system 10, CE public key certificate acquisition processing section 330 receives a permanent certificate issuance request, and transmits that permanent certificate issuance request to public key certificate issuing station 400 via a secure channel using a temporary certificate; and public key certificate issuing station 400 is equipped with: public key certificate database 430 that is capable of storing a temporary certificate or permanent certificate and a terminal key certificate in mutually associated form; and permanent public key certificate issuance processing section 420 that searches public key certificate database 430 in response to a permanent certificate issuance request, and when a temporary certificate included in the permanent certificate issuance request is stored in public key certificate database 430, issues a permanent certificate and transmits this to CE public key certificate acquisition processing section 330, and also stores the permanent certificate and identification information of CE device 300 that is the transmission source of the permanent certificate issuance request in public key certificate database 430.

By this means, authentication based on a temporary certificate becomes possible between CE device 300 and public key certificate issuing station 400, and CE device 300 can acquire a permanent certificate from public key certificate issuing station 400 using a secure channel formed thereby. Also, since CE device information and a terminal key certificate are stored in mutually associated form, when, for example, CE device 300 performs a content download or the like and a charge is incurred, charging can be performed collectively for mobile terminal 200 identified by the terminal key certificate corresponding to the CE device information.

Also, in above-described authentication system 10, public key certificate issuing station 400 is equipped with: user information database 440 that stores destination information relating to mobile terminal 200; and mobile terminal notification processing section 460 that, before a permanent certificate is issued and transmitted to CE device 300, transmits an issuance permission confirmation notification to mobile terminal 200 using the destination information.

By this means, security can be improved by preventing illegal acquisition of a permanent certificate by using CE device 300 and IC card 100 by a person other than the user of mobile terminal 200 that issued and transmitted a temporary certificate.

Also, according to this embodiment, IC card 100 is equipped with: key/certificate storage section 120 that is capable of storing a key pair and a temporary certificate or permanent certificate in mutually associated form; CE temporary public key certificate acquisition processing section 170 that is connected to mobile terminal 200 and, when a key pair that is not associated with either a temporary certificate or a permanent certificate exists in key/certificate storage section 120, acquires a temporary certificate corresponding to the key pair from public key certificate issuing station 400 using mobile terminal 200 and stores this in key/certificate storage section 120; and CE public key/certificate acquisition control section 150 that is connected to CE device 300 and, when a key pair that is associated with a temporary certificate but is not associated with a permanent certificate exists in key/certificate storage section 120, acquires a permanent certificate from public key certificate issuing station 400 using the temporary certificate via CE device 300 and stores this in key/certificate storage section 120.

By this means, it is generally possible for a user to be identified, a temporary certificate of a key to be acquired in IC card 100 using high-reliability mobile terminal 200, IC card 100 and CE device 300 then to be connected, and a permanent certificate of the key used by CE device 300 to be acquired using the temporary certificate obtained in a high-reliability environment. Therefore, a permanent certificate of a key can be acquired in a high-reliability environment even when CE device 300 does not have a user registered. Also, heretofore it has been necessary for a user to perform a complex user registration procedure by mail or the like, and then further perform complex processing to acquire device authentication information such as a key and key certificate, each time the user acquires a CE device, but by using above-described IC card 100, key and key certificate acquisition processing is simplified, and user-friendliness can be improved.

Also, according to this embodiment, CE device 300 is equipped with CE public key certificate acquisition processing section 330 that is connected to above-described IC card 100, receives a permanent certificate issuance request from CE public key/certificate acquisition control section 150 of IC card 100, transmits that permanent certificate issuance request to public key certificate issuing station 400 via a secure channel using a temporary certificate, receives a permanent certificate issued by public key certificate issuing station 400 in response to that permanent certificate issuance request, and sends that permanent certificate to IC card 100.

Also, according to this embodiment, mobile terminal 200 is equipped with CE public key certificate acquisition processing section 250 that is connected to above-described IC card 100, and, on reception of a temporary certificate issuance request from CE temporary public key certificate acquisition processing section 170 of that IC card 100, transmits a temporary certificate issuance request to public key certificate issuing station 400 via a secure channel using the terminal key pair and terminal key certificate of that apparatus, receives a temporary certificate issued by public key certificate issuing station 400 in response to that temporary certificate issuance request, and sends that temporary certificate to IC card 100.

Also, according to this embodiment, public key certificate issuing station 400 that performs communication with above-described CE device 300 is equipped with: public key certificate database 430 that is capable of storing a temporary certificate or permanent certificate and a terminal key certificate in mutually associated form; and permanent public key certificate issuance processing section 420 that searches public key certificate database 430 in response to a permanent certificate issuance request from CE public key certificate acquisition processing section 330 of CE device 300, and when a temporary certificate included in the permanent certificate issuance request is stored in public key certificate database 430, issues a permanent certificate and transmits this to the key certificate acquisition section of the CE device, and also stores that permanent certificate and identification information of CE device 300 that is the transmission source of the permanent certificate issuance request in public key certificate database 430.

Also, according to this embodiment, public key certificate issuing station 400 that performs communication with above-described mobile terminal 200 is equipped with: public key certificate database 430 that is capable of storing a temporary certificate or permanent certificate and a terminal key certificate in mutually associated form; and temporary public key certificate issuance processing section 410 that issues a temporary certificate in response to a temporary certificate issuance request from CE public key certificate acquisition processing section 330 of CE device 300 and transmits that temporary certificate to CE public key certificate acquisition processing section 330 of CE device 300, and also stores the issued temporary certificate and the terminal key certificate of mobile terminal 200 that is the transmission source of the temporary certificate issuance request in public key certificate database 430 in mutually associated form.

### INDUSTRIAL APPLICABILITY

An authentication system, CE device, mobile terminal, key certificate issuing station, and key certificate acquisition method of the present invention have an effect of improving user-friendliness, and are useful as an authentication system, CE device, mobile terminal, key certificate issuing station, and key certificate acquisition method using a PKI for authentication.

1. An authentication system having a mobile terminal, a CE device, an IC card that is connectable to the mobile terminal and the CE device, and a key certificate issuing station that issues a temporary certificate and permanent certificate for a key pair composed of a public key and private key used by the CE device,
wherein the IC card comprises:
a storage section that is capable of storing the key pair and the temporary certificate or the permanent certificate in mutually associated form;
a first key certificate acquisition section that acquires a temporary certificate corresponding to the key pair from the key certificate issuing station using the mobile terminal and stores this in the storage section when the first key certificate acquisition section is connected to the mobile terminal and the key pair that is not associated with either the temporary certificate or the permanent certificate exists in the storage section; and
a second key certificate acquisition section that acquires the permanent certificate from the key certificate issuing station using the temporary certificate via the CE device and stores this in the storage section when the second key certificate acquisition section is connected to the CE device and the key pair that is associated with the temporary certificate but is not associated with the permanent certificate exists in the storage section.

2. The authentication system according to claim 1, wherein:
when the first key certificate acquisition section is connected to the mobile terminal and the key pair that is not associated with either the temporary certificate or the permanent certificate exists in the storage section, the first key certificate acquisition section sends a temporary certificate issuance request corresponding to the key pair to the mobile terminal; and
the mobile terminal comprises a third key certificate acquisition section that, on reception of the temporary certificate issuance request, acquires the temporary certificate from the key certificate issuing station via a secure channel using a terminal key pair and terminal key certificate of that apparatus, and sends that temporary certificate to the IC card.

3. The authentication system according to claim 1, wherein:
when the second key certificate acquisition section is connected to the CE device and the key pair that is associated with the temporary certificate but is not associated with the permanent certificate exists in the storage section, the second key certificate acquisition section sends a permanent certificate issuance request including the key pair and the temporary certificate to the CE device; and
the CE device 300 comprises a fourth key certificate acquisition section that, on reception of the permanent certificate issuance request, acquires the permanent certificate from the key certificate issuing station via a secure channel using the temporary certificate, and sends that permanent certificate to the IC card.

4. The authentication system according to claim 2, wherein:
the third key certificate acquisition section, on reception of the temporary certificate issuance request, transmits the temporary certificate issuance request to the key certificate issuing station via a secure channel using a terminal key pair and terminal key certificate of that apparatus; and
the key certificate issuing station comprises:
an issuing station storage section that is capable of storing the temporary certificate or the permanent certificate and the terminal key certificate in mutually associated form; and
a temporary certificate issuance control section that, on reception of the temporary certificate issuance request, issues the temporary certificate and transmits that temporary certificate to the third key certificate acquisition section, and also stores the issued temporary certificate and the terminal key certificate of the mobile terminal that is a transmission source of the temporary certificate issuance request in the issuing station storage section in mutually associated form.

5. The authentication system according to claim 3, wherein:
the fourth key certificate acquisition section receives the permanent certificate issuance request, and transmits that permanent certificate issuance request to the key certificate issuing station via a secure channel using the temporary certificate; and
the key certificate issuing station comprises:
an issuing station storage section that is capable of storing the temporary certificate or the permanent certificate and the terminal key certificate in mutually associated form; and
a permanent certificate issuance control section that searches the issuing station storage section in response to the permanent certificate issuance request, and when the temporary certificate included in the permanent certificate issuance request is stored in the issuing station storage section, issues the permanent certificate and transmits this to the fourth key certificate acquisition section, and also stores that permanent certificate and identification information of the CE device that is a transmission source of the permanent certificate issuance request in the information storage section.

6. The authentication system according to claim 1, wherein:
the key certificate issuing station comprises:
a storage section that stores destination information relating to the mobile terminal; and
a confirmation section that, before the permanent certificate is issued and transmitted to the CE device, transmits an issuance permission confirmation notification to the mobile terminal using the destination information.

7. An IC card comprising:
a storage section that is capable of storing a key pair and a temporary certificate or permanent certificate in mutually associated form;
a first key certificate acquisition section that acquires a temporary certificate corresponding to the key pair from a key certificate issuing station using the mobile terminal and stores this in the storage section when the first key certificate acquisition section is connected to a mobile terminal and the key pair that is not associated with either the temporary certificate or the permanent certificate exists in the storage section; and
a second key certificate acquisition section that acquires the permanent certificate from the key certificate issuing station using the temporary certificate via the CE device and stores this in the storage section when the second key certificate acquisition section is connected to the CE device and the key pair that is associated with the temporary certificate but is not associated with the permanent certificate exists in the storage section.

8. A CE device comprising a key certificate acquisition section that is connected to the IC card according to claim 7, receives a permanent certificate issuance request from the second key certificate acquisition section of that IC card, transmits that permanent certificate issuance request to the key certificate issuing station via a secure channel using a temporary certificate, receives the permanent certificate issued by the key certificate issuing station in response to that permanent certificate issuance request, and sends that permanent certificate to the IC card.

9. A mobile terminal comprising a key certificate acquisition section that is connected to the IC card according to claim 7, and, on reception of a temporary certificate issuance request from the first key certificate acquisition section of that IC card, transmits the temporary certificate issuance request to the key certificate issuing station via a secure channel using a terminal key pair and terminal key certificate of that apparatus, receives the temporary certificate issued by the key certificate issuing station in response to that temporary certificate issuance request, and sends that temporary certificate to the IC card.

10. A key certificate issuing station that performs communication with the CE device according to claim 8, the key certificate issuing station comprising:
an issuing station storage section that is capable of storing a temporary certificate or permanent certificate and a terminal key certificate in mutually associated form; and
a permanent certificate issuance control section that searches the issuing station storage section in response to a permanent certificate issuance request from a key certificate acquisition section of the CE device, and when the temporary certificate included in the permanent certificate issuance request is stored in the issuing station storage section, issues the permanent certificate and transmits this to the key certificate acquisition section of the CE device, and also stores that permanent certificate and identification information of the CE device that is a transmission source of the permanent certificate issuance request in the issuing station storage section.

11. A key certificate issuing station that performs communication with the mobile terminal according to claim 9, the key certificate issuing station comprising:
an issuing station storage section that is capable of storing a temporary certificate or permanent certificate and a terminal key certificate in mutually associated form; and
a temporary certificate issuance control section that issues the temporary certificate in response to a temporary certificate issuance request from a key certificate acquisition section of the CE device and transmits that temporary certificate to the key certificate acquisition section of the CE device, and also stores the issued temporary certificate and the terminal key certificate of the mobile terminal that is a transmission source of the temporary certificate issuance request in the issuing station storage section in mutually associated form.

12. A key certificate acquisition method that acquires a permanent certificate of a key used by a CE device, the key certificate acquisition method comprising:
a step of connecting an IC card and a mobile terminal, and the IC card, when the key that is not associated with either the permanent certificate or the temporary certificate exists in a storage section of the IC card, acquiring a temporary certificate corresponding to the key from the key certificate issuing station using the mobile terminal; and
a step of connecting the IC card and the CE device, and the IC card acquiring the permanent certificate from the key certificate issuing station using the temporary certificate via the CE device.
